(19) United States
(12) Patent Application Publication
(10) Pub. No.: US 2006/0164198 A1
(43) Pub. Date: Jul. 27, 2006

(54) Switching power supply

(76) Inventor: Marcello Givoletti, Camaiore (IT)

Correspondence Address: Gunnar G Leinberg;Nixon Peabody, Clinton Square, PO Box 31051, Rochester, NY, 14603-1051, US

(21) Appl. No.: 10/548,157

(22) PCT Filed: Mar. 2, 2004
(86) PCT No.: PCT/EP04/02070

§ 371 Date: Sep. 6, 2005

(30) Foreign Application Priority Data
Mar. 3, 2003 (IT) FI2003 A 000053

(51) Int. Cl. H01F 27/24

(52) U.S. Cl. 336/233

(57) ABSTRACT

The present application describes switching power supplies provided with a transformer which allows their use in intense magnetic fields

### FIELD OF INVENTION

The invention refers to the field of switching power supplies.

### STATE OF THE ART

The diffusion of electronics has led to a growing importance of power supplies, devices which convert direct or alternating input voltages generally into direct output voltages, whose level depends on the device to be supplied (3.3V, 5V, 12V, 15V etc.).

The switching power supplies, represent the most important category of power supplies.

In power supplies of this kind, a direct input voltage, that may be obtained by the rectification of an alternating voltage, is fed to a fixed or variable frequency oscillator which in turn generates an alternating voltage.

This alternating voltage is fed to the primary winding of a transformer, having a bandwidth compatible with the oscillator frequency and a turns ratio capable of a secondary voltage which is enough once rectified and filtered, to obtain an output voltage equal to the desired direct output voltage.

Its clear how the transformer, as well as all the inductive elements of the switching power supplies, play a central role in the voltage converter structure. These components are generally built placing the windings around a ferromagnetic core. Said core forms the path for the magnetic flux which is generated by the primary winding current and transfers onto the secondary the input power of the converter.

The characteristic parameters of the inductive components depend on the capability of their core of sustaining an adequate magnetic flux. An external magnetic field present in the region where the power supply operates, may affect its operation.

The external magnetic flux may modify the magnetic flux inside the core, thus altering the transformer operation and its characteristic parameters (primary inductance, secondary inductance, leakage inductance, equivalent turns ratio).

This may happen when the power supply operates within intense static magnetic fields, as in the case of the circuitry of the particle accelerators employed in experimental nuclear physics.

If the external magnetic field is particularly intense, core saturation may occur, thus inhibiting any energy transfer from the primary side to the secondary side of the transformer and preventing the whole power supply from correct operation.

The presently available power supplies are able to operate correctly within magnetic fields up to 100 Gauss; Appropriate shielding may raise this threshold up to 300 Gauss, but shielding is expensive, cumbersome and difficult to implement.

It is thus evident the need to overcome the above limitations introducing transformers which are able to operate even within high intensity magnetic fields, and without shielding.

### SUMMARY OF THE INVENTION

The invention is referred to commutation power supplies which include a transformer whose core features a low relative magnetic permeablity (μ), capable of operation under highly intense magnetic fields.

### INVENTION DETAILED DESCRIPTION

The present invention refers to switching power supplies including a transformer containing a low relative magnetic permeablity (μ) core, capable of operating within high intensity external magnetic fields.

The transformer according to the present invention is realised employing low relative magnetic permeablity (μ) cores; typical μ values range from 1 to 100.

The use of low relative magnetic permeablity (μ) materials allows the transformer cores to offer a high reluctance path to the flux of the external magnetic field. In this way the transformer parameters are almost insensitive to said external field since the flux caused, inside the core, by the external field can be neglected with respect to the flow caused by the primary currents.

The use of low permeablity materials leads to low primary inductance values and, as a consequence, high primary magnetisation current values, high values of energy stored in the core and high leakage inductance (the leakage inductance is defined as the inductance related to the leakage flux of the transformer). The solutions which implement transformers with low permeability cores must achieve an efficient use of this larger amount of energy, which would be otherwise dissipated.

Low permeability cores, such as those used in the transformetrs according to the present inventiont, are usually employed in high frequency circuits, typically in the radio frequency range (f>1 MHz), while in present switching power supllies transformers are used with cores having permeabilty values higher than 1000, with a 100÷200 kHz operating frequency.

The transformers according to the present invention are optimised for operation at frequencies lower than 500 kHz and have proved to operate correctly up to 10000 Gauss: 100 times above the limit operating level of state-of-the-art transformers.

1. A switching power supply, comprising a transformer containing a core of low relative magnetic permeability (μ) material.

2. The switching power supply according to claim 1, wherein said low relative magnetic permeability material is a ferromagnetic material.

3. The switching power supply according to claim 2, wherein said relative magnetic permeability is comprised in the range 1÷100.

4. A method for supplying power to electronic apparatuses wherein a switching power supply according to claim 1 is used.

5. The method according to claim 4, wherein said power supplying is performed in environments interested by magnetic fields having intensity of up to 10,000 Gauss.
